(19) United States
(12) Patent Application Publication
(10) Pub. No.: US 2012/0012615 A1
(43) Pub. Date: Jan. 19, 2012

(54) Cartridge with flushing

(76) Inventor: Sasan Habibi-Naini, Rikon (CH)

(21) Appl. No.: 13/135,849

(22) Filed: Jul. 15, 2011

(30) Foreign Application Priority Data
Jul. 16, 2010 (EP) 10169853.8

(51) Int. Cl. B67D 1/08; G01F 11/00

(52) U.S. Cl. 222/148; 222/386

(57) ABSTRACT

The cartridge contains a storage container for the filler material with a first piston arranged in the storage container by means of which the filler material can be dispensed through an outlet passage. A second piston is arranged in the storage container in spaced relation to the first piston to contain a flushing fluid therebetween. A flushing element is provided near the outlet passage by means of which the flushing fluid can be conducted past the first piston into the outlet passage at the end of a dispensing procedure.

This invention relates to a cartridge for dispensing a fluid filler material.

Cartridges for dispensing filler materials, which may be made of one or more components, have been used for some time. Solutions have been developed to dispense the filler material once in a specific dose, that is single use solutions. There are also cartridges for which a multiple use is generally permissible. This means that such cartridges are only partly dispensed and are subsequently closed again. When closing them again, care must be taken that the filler material is not contaminated. In particular with multicomponent cartridges which contain a plurality of reactive components, a contamination would have the result, that the cartridge becomes unusable because the reactive components react and harden as a rule and block the discharge opening.

There is therefore a need with respect to a reusability of the cartridge to clean the cartridge such that the cartridge can be made accessible for a repeated use free of residues of filler material.

A further problem is the remaining of filler material in the cartridge after the completion of the dispensing procedure. The dispensing does not take place completely so that small residues of reactive filler material remain in the storage space and can no longer be removed. Since the filler material is often highly reactive, a disposal of the cartridge together with the filler material as hazardous waste is required, which represents a not inconsiderable volume of waste.

An already known process for cleaning a cartridge is to provide a capsule having a neutralization fluid, with the capsule being pierced at the end of the dispensing so that the neutralization fluid pours out into the storage space and chemically neutralizes any residues of filler material. This solution is disadvantageous in that parts of the capsule may remain in the storage space and the cartridge can admittedly be disposed of without concern, but is no longer suitable for reuse.

It is therefore an object of the invention to provide a means to remove the filler material completely from the storage space of the cartridge as well as to prepare the cartridge for a reuse.

Briefly, the invention provides a cartridge for dispensing a filler material which contains a storage container for the filler material, wherein a first piston is arranged in the storage container by means of which the storage container can be closed in a fluid-tight manner and a filler material can be stored between the first piston and an outlet passage in the storage container and wherein the first piston can be acted on by a compressive force so that the filler material can be dispensed from the storage container through the outlet passage. The piston has a media side facing the filler material and an oppositely disposed drive side. A second piston is arranged in the storage container which is located at the drive side of the first piston. The intermediate space between the first piston and the second piston is filled with a flushing fluid. A flushing element is provided so that the flushing fluid can be conducted past the first piston into the outlet passage at the completion of the dispensing procedure.

Any residues of filler material are thus taken up by the flushing fluid and are disposed of through the outlet passage with the flushing fluid. Filler material residues can thus be removed from the storage container by the flushing fluid. No residues of the reactive filler material remain in this process.

The flushing element is formed as a flushing passage which is closed as long as the filler material is in the storage container. The flushing passage can be provided in the piston, for example, and can be closed by a blocking element or, as described in the following, it can extend at the inner wall of the storage container. The flushing element can in particular be a venting gap. Such a venting gap can be provided as in PCT/EP2010/057512 to remove air present between the piston and the filler material from the storage space on the filling of the cartridge with filler material so that no air inclusions remain between the piston and the filler material. For this purpose, the flushing element is arranged at the inner wall of the storage container, with existing venting gaps being able to be used.

The flushing element is in particular formed as an elevated portion at the inner wall of the storage container. The seal between the piston and the inner wall is locally interrupted by this elevated portion so that flushing fluid can be conducted into the storage space and from there into the outlet passage. The flushing element has a length which at least corresponds to the height of the first piston. When the piston lies on the end face of the storage container, the flushing fluid can be conducted past the piston by the flushing element.

The flushing element is configured for this purpose such that a piston seal of the first piston can be released from the inner wall of the storage container when the first piston is in a position in which a piston seal is engaged by the elevated portion, whereby a passage for the flushing fluid can be released. The piston seal can be formed, for example, as a piston lip which lies on the inner wall of the storage container.

The flushing element extends at the inner wall of the storage container from its end face over at least the height of the first piston and is smaller than the total height of the first and second pistons.

A plurality of flushing elements can be provided. A plurality of flushing elements can in particular be distributed at the periphery of the storage container. These flushing elements are formed as displacement ribs, for example.

The viscosity of the filler material is advantageously less than the viscosity of the flushing fluid. If the flushing fluid had a smaller viscosity than the filler material, the flushing fluid could flow past the filler material without removing the filler material. In this case, a complete flushing of the storage space is not ensured.

The volume of the flushing fluid which is present between the first and second pistons is advantageously at least as large as the volume of the outlet passage. It is hereby ensured that the filler material residues are reliably removed from the storage space and from the outlet passage when the flushing is completed.

The storage container can in particular have an inner wall and an end face, wherein the end face has an outlet opening which the outlet passage adjoins, with the diameter of the outlet opening amounting as a maximum to a third of the diameter of the storage container.

The outlet opening is the inlet end of the outlet passage and the outlet passage has an outlet end to which a mixing element can be connected.

The cartridge can in particular be formed as a multicomponent cartridge, for example in the construction of PCT/EP2010/057512 whose content is hereby incorporated by reference and made an integral part of hereof.

These and other objects and advantages of the invention will become more apparent from the following detailed description taken in conjunction with the drawings wherein:

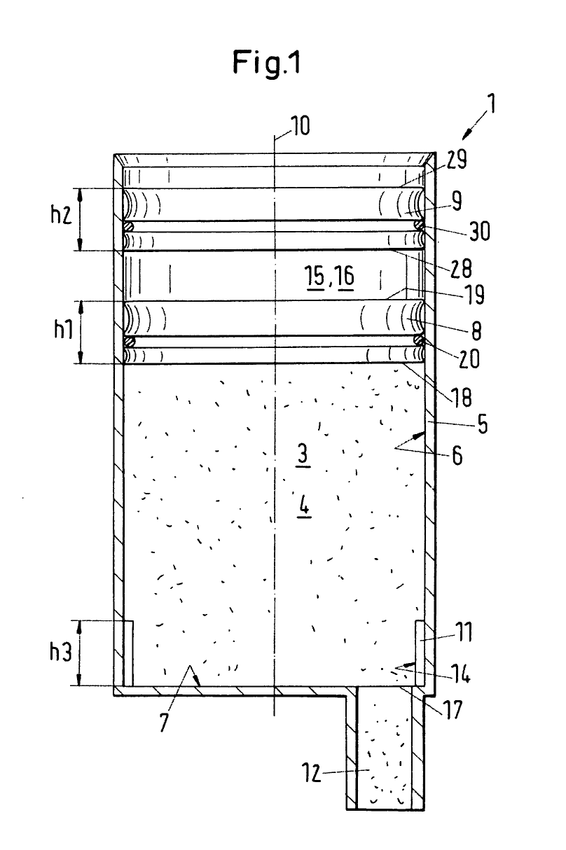

FIG. 1 is a schematic representation of a cartridge in accordance with the invention filled with a filler material and a flushing fluid;

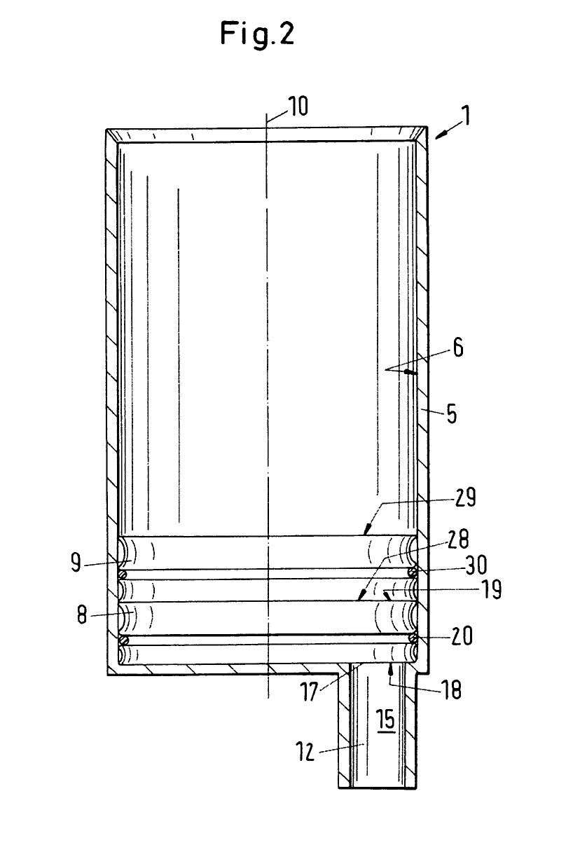

FIG. 2 is a schematic representation of the cartridge of FIG. 1 after dispensing of the filler material; and

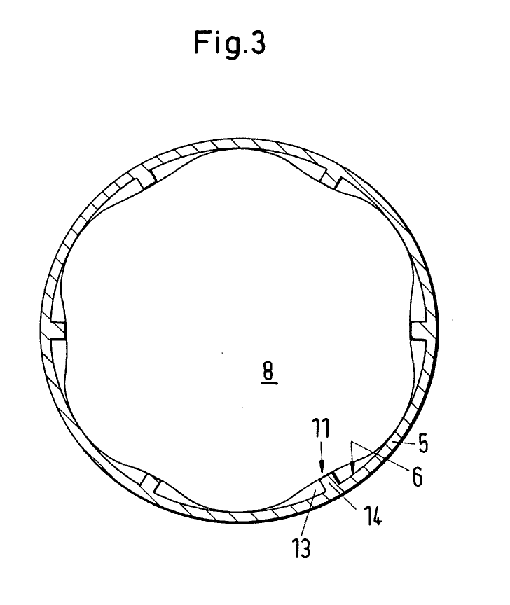

FIG. 3 is a section through a cartridge in accordance with the invention.

Referring to FIG. 1, in a preferred embodiment, a cartridge 1 is filled in a conventional manner with a filler material 3 that is to be dispensed. The filler material 3 is, as a rule, a liquid which is present in a storage container 5 within the cartridge 1. The storage container 5 is part of the cartridge and has an inner wall 6 and an end face 7. The inner wall 6 is arranged coaxially to the longitudinal axis 10 of the cartridge 1. The end face 7 contains an outlet passage 12 through which the filler material 3 is dispensed from the storage container 5. A first piston 8 by means of which the storage container 5 can be closed in a fluid-tight manner is arranged in the storage container 5. A storage space 4 in which the filler material 3 is storable is formed by the first piston 8, the storage container 5 and the outlet passage 12 which can be closed by a closure element, not shown.

The first piston 9 has a media side 18 facing the filler material 3 and a drive side 19 disposed opposite the media side 18. The first piston 8 can be acted on by a compressive force at the drive side 19 so that the filler material 3 can be dispensed from the storage container 5 through the outlet passage 12 in that the first piston 8 is moved along the inner wall 6 in the direction of the outlet passage 12.

When the first piston 8 reaches the end face 7, the procedure of dispensing is complete. However, residual filler material 3 is still present between the first piston 8 and the end face 7 as well as in the outlet passage 12. If this filler material 3 contains a reactive component, a chemical reaction can occur in the outlet passage 12 which is in contact with the air of the environment. A reactive filler material furthermore frequently represents a risk for the environment so that a cartridge 1 contaminated with such a reactive filler material 3 previously had to be disposed of as hazardous waste. A flushing is therefore provided in accordance with the invention so that the filler material is completely removed from the storage space.

A second piston 9 is arranged in the storage container 5 for this purpose. The second piston 9 is arranged on the drive side 19 of the first piston 8. A flushing fluid 15 is present between the first piston 8 and the second piston 9. The first piston 8 has a piston seal 20 and the second piston 9 has a piston seal 30. The flushing fluid 15 is present between the first piston 8 and the second piston 9. An exiting of the flushing fluid into the storage space 5 is prevented by the piston seal 20. An exiting of the flushing fluid 15 into the environment is prevented by the piston seal 30.

The second piston 9 has a media side 28 and a drive side 29, with the media side 28 being in contact with the flushing fluid. The drive side 19 of the first piston 8 is likewise in contact with the flushing fluid 15. The flushing fluid 15 is substantially incompressible and remains in the intermediate space 16 between the media side 28 of the second piston 9 and the drive side 19 of the first piston 8 as long as the piston seals 20, 30 lie completely on the inner wall 6 of the storage container 5.

The second piston 9 is acted on by a compressive force to dispense the filler material 3. This compressive force can be applied, for example, by a pressure fluid or by a plunger. Both variants are familiar to the skilled person and are therefore not shown graphically. When the second piston is acted on by a compressive force, it is displaced in the direction of the end face 7. The first piston 8 and the flushing fluid 15 present in the intermediate space 16 are simultaneously displaced with the second piston 9. The filler material 3 leaves the storage container 5 through an outlet opening 17 and the outlet passage 12.

As illustrated, the outlet opening 17 adjoins the outlet passage 12 with the diameter of the outlet opening 17 amounting, as a maximum, to a third of the diameter of the storage container 5.

To remove the filler material 3 remaining in the storage space 4 after the end of the dispensing procedure, a flushing element 11 is provided so that the flushing fluid 15 can be conducted past the first piston 8 into the outlet passage 12 at the end of the dispensing procedure. Any residues of filler material 3 are thus taken up by the flushing fluid 15 and are expelled through the outlet passage 12 with the flushing fluid 15. Filler material residues can thus be completely removed from the storage container by the flushing fluid 15 so that no residues of the reactive filler material remain in the storage space 4.

In accordance with FIG. 1 or FIG. 3, a flushing passage 13 is formed by the flushing element 11 and is closed as long as the filler material 3 is present in the storage container 5. The flushing passage 13 is visible in FIG. 3. The flushing passage 13 extends along the inner wall 6 of the storage container 5.

The flushing element 11 is formed as an elevated portion 14 at the inner wall of the storage container 5 which projects into the storage space, as is shown in FIG. 3. The seal between the first piston 8 or its piston seal 20 respectively and the inner wall 6 is locally interrupted by this elevated portion 14 so that flushing fluid 15 can be conducted into the storage space 4 and from there into the outlet passage 12. The flushing element 11 has a length which at least corresponds to the height of the first piston 8. When the first piston 8 lies on the end face 7 of the storage container 5, the flushing fluid 15 can be conducted past the first piston 8 by the flushing element 11.

The flushing element 11 extends at the inner wall 6 of the storage container 5 from its end face 7 over at least the height h1 of the first piston 8 and is smaller than the total height h1+h2 of the first piston 8 and of the second piston 9. If the flushing element 11 has a height h3, it applies that h3 is larger than h1, but smaller than h1+h2.

FIG. 3 shows a section through the first piston 8 when in the position shown in FIG. 2. A plurality of flushing elements 11 are provided at the inner wall 6 which are distributed at the periphery of the storage container. These flushing elements 11 are formed as elevated portions 14, as displacement ribs, for example. A release of the piston seal 20 takes place at the elevated portions 14 so that a flushing passage 13 is created. The flushing fluid flows through the flushing passage or through all flushing passages shown in FIG. 3 into the storage space 4 which is substantially made up of the outlet passage 12 (see FIG. 2).

What is claimed is:

1. A cartridge for dispensing a filler material comprising
a storage container for receiving a filler material, said storage container having an outlet at one end thereof for dispensing the filler material therethrough;
a first piston slidably disposed in said storage container in fluid-tight manner for dispensing the filler material from said storage container through said outlet passage in response to movement of said first piston towards said outlet passage;
a second piston slidably disposed in said storage container on a side of said first piston opposite said outlet passage and spaced from said first piston;
a flushing fluid present between said first piston and said second piston; and
at least one flushing element for flushing the flushing fluid past said first piston into said outlet passage after dispensing of the filler material from said storage container.

2. A cartridge as set forth in claim 1 wherein said flushing element forms a flushing passage between said first piston and said flushing element and communicating with said flushing fluid present between said first piston and said second piston.

3. A cartridge as set forth in claim 1 wherein said flushing element is arranged at an inner wall of said storage container.

4. A cartridge as set forth in claim 1 wherein said flushing element is an elevated portion at an inner wall of said storage container.

5. A cartridge as set forth in claim 1 wherein said flushing element has a length which corresponds at least to the height of said first piston.

6. A cartridge as set forth in claim 1 wherein said first piston has a circumferential seal sealingly engaging an inner wall of said storage container, said seal passing over said flushing element with said first piston disposed adjacent said outlet passage to form a passage therebetween for said flushing fluid to be released.

7. A cartridge as set forth in claim 1 wherein said flushing element extends along an inner wall of said storage container from an end face over at least the height of said first piston and a height smaller than the total height of said first piston and of said second piston.

8. A cartridge as set forth in claim 1 having a plurality of said flushing elements disposed circumferentially of said storage container.

9. A cartridge as set forth in claim 1 wherein said flushing fluid has a viscosity greater than the viscosity of the filler material.

10. A cartridge as set forth in claim 1 wherein the volume of said flushing fluid present between said first piston and said second piston is at least as large as the volume of said outlet passage.

11. A cartridge as set forth in claim 1 wherein said storage container has an inner wall and an end face, said end face having an outlet opening adjoining said outlet passage with the diameter of said outlet opening amounting as a maximum to a third of the diameter of said storage container.

12. A cartridge as set forth in claim 11 wherein said outlet opening is an inlet end of said outlet passage and said outlet passage has an outlet end to which a mixing element can be connected.
